(19) United States
(12) Patent Application Publication
(10) Pub. No.: US 2005/0038749 A1
(43) Pub. Date: Feb. 17, 2005

(54) Method, system and apparatus for media distribution and viewing verification

(76) Inventors: Stephan J Fitch, New York, NY (US); David S Segalowitz, Brooklyn, NY (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/499,308

(22) PCT Filed: Dec. 20, 2002
(86) PCT No.: PCT/US02/41666

(30) Foreign Application Priority Data
Dec. 21, 2001 (US) 60343342

(51) Int. Cl. G06F 17/60

(52) U.S. Cl. 705/51

(57) ABSTRACT

The present invention is directed to a method, system and apparatus for media distribution and/or viewing verification. In one embodiment of the present invention, media content is stored in a database. Media content from the database is arranged into a schedule and displayed on a display unit. In one embodiment, the display unit comprises a flat panel display with stereo speakers placed in a wall in approximately the same space as is occupied by a traditional movie poster display case. In one embodiment, the display unit is retro-fitted to a traditional movie poster display case. In one embodiment, a display unit has a sensor unit. One embodiment has motion sensors used in determining whether the display is being viewed. Another embodiment has video sensors used in determining whether the display is being viewed and/or determining the number of viewers. Another embodiment has a card reader sensor used to gather information about a viewer. Another embodiment has a touch-screen monitor used to gather information from a viewer.

### RELATED APPLICATION INFORMATION

This application claims the benefit of U.S. Provisional Patent Application Ser. No. 60/343,342, filed Dec. 21, 2001, entitled, “Method, System and Apparatus for Media Distribution and Viewing Verification,” the disclosure of which is hereby incorporated by reference in its entirely.

### FIELD OF THE INVENTION

The present invention relates to the field of media distribution, and in particular to a method, system and apparatus for media distribution and viewing verification.

### BACKGROUND OF INVENTION

Posters of still images are frequently used to advertise services and products. For example, movie theaters often display posters of upcoming new releases. However, since the posters are static, only a limited number of items can be displayed at one given time. Additionally, the posters are limited in their ability to attract viewers' attention and there is no method of verifying for an advertiser that a poster was viewed by anyone, and to quantify the number of viewers in a particular time period

### SUMMARY OF THE INVENTION

It is an object of the present invention to provide a method, system and apparatus for media distribution and viewing verification. In one embodiment, media content is stored in a database. Media content from the database is arranged into a schedule and displayed on a display unit In one embodiment, the display unit comprises a flat panel display with stereo speakers placed in a wall in approximately the same space as is occupied by a traditional movie poster display case. In one embodiment, the display unit is retro-fitted to a traditional movie poster display case. In another embodiment, the display unit is a stand alone unit, for example, sitting on or mounted to a floor. In alternative embodiments, the display unit is suited for positioning or mounting on a counter, shelf, desk, dashboard, table, elevator, video intercom, vehicle body and the like.

It is also an object of the present invention to provide a display unit comprising one or more sensor units. One embodiment has motion sensors used in determining whether the display is being viewed. Another embodiment has video sensors used in determining whether the display is being viewed and/or determining the number of viewers. Yet another embodiment has a card reader sensor used to gather information about a viewer. Another embodiment has a touch-screen monitor used to gather information from a viewer. Other embodiments have sensors used to receive information from portable electronic devices, including but not limited to cellular phones, PDAs or laptops. In one embodiment, the display unit also may comprise a communications unit configured to transmit information to portable electronic devices. In one embodiment, an infrared port is used by the communications unit. In other embodiments, other communications means are used by the communications unit.

It is another object of the present invention to provide a display unit for collecting information about the number and type of viewers that attend each media segment. This information is used to verify content viewing. In one embodiment, the information is transmitted to a database. Verified viewings are associated with a value which, in some embodiments, is combined with a baseline display value.

It is a further object of the present invention to provide a method, system and apparatus for media distribution and viewing verification comprising a display unit for viewing media content, the media content segmented into ads. Ads may comprise still video, moving video, audio and interactive feature instructions. For example, one ad is a still picture that displays until the display unit detects a viewer's presence. Once the viewer's presence is detected, the ad begins playing moving video and sound. In one embodiment, the still picture and moving video are arranged such that it appears to the viewer that the still image begins to move when they view the display. In one embodiment, the display unit determines the type of viewers using it and rearranges its display schedule to display ads that are of interest to the current viewers. In one embodiment, the display unit can identify individual viewers. For example, a viewer may present a smart card to the display unit containing information about the viewer. As the display unit displays ads, it modifies the information on the user's smart card. Thus, when the viewer presents its smart card to another display, the viewer's history can be taken into account when scheduling ads for the viewer.

It is also an object of the present invention to provide a database for storing information about a user. When a display unit identifies an individual, it rearranges its ad display schedule to accommodate the individual given the information it has about the individual. In some embodiments, the display unit will retrieve a set of information about a viewer from a smart card used to identify the viewer. The display unit will also send a request for more complete information and/or ad content to a database. In one embodiment, a local database contains an incomplete pool of ads and viewer information. Only the ads that are deemed likely to be displayed within a period of time are stored on the local database. Additionally, only the viewer information of viewers deemed likely to be present is stored on the local database. If a display requests viewer or ad information not stored in the local database, the local database requests the information from a central database that stores a complete pool of ads and viewer information. Likewise, the display unit's interactions with a viewer may cause the viewer's information to be altered both on the local database and on the central database. In one embodiment, the local database updates its stored information from the central database on a regular basis.

It is another object of the present invention to provide a method, system and apparatus for coordinating ads between multiple displays. This is accomplished through one or more synched events between the displays. For example, a character can be made to appear to run from one display to another or characters and scenes on one or more different displays can interact (e.g., a character shooting a flame thrower onto another screen or two characters playing catch). In one embodiment, the relative positions of the interacting display units are used in scheduling the displays on each display unit For example, if three displays are interacting with a character running from the first to the last display unit in a row and the first and second display are one unit apart while the second and third units are three units apart, the schedules of the displays on each unit are arranged such that it appears to take three times as long for the character to traverse the space between the second and third display units as it does to traverse the distance between the first and the second display. In one embodiment, the relative position of the display units is determined using a GPS receiver.

With respect to multiple display events, the trigger event can be derived from an external source to coordinate related content being played on two or more screens. In one embodiment, the external source is another display unit where another triggered event (e.g., time elapse, motion, card) requires the participation of said display unit to perform the requested action. In another embodiment, a program on a server triggers events on multiple displays based on prescheduled requirements. For example, to play related content on all display units in a location at a certain time. In another embodiment, a program on a server coordinates any triggered events requiring the participation of multiple displays to choose the most appropriate content for the given request and scheduling scenario of the display units involved. For example, if an event is triggered by motion and the motion event specifies both content that can be played on three screens, on two screens and on a single screen the coordinating program would check to see if there were display units available to fill the request in proper proximity to one another to play the three screen content, if not then the two screen content, finally the single screen content. In addition, the coordinating program would make sure the proper content existed on the available display units and if were not, the server could stream it directly to the display unit.

It is further an object of the present invention to provide a method, system and apparatus for media distribution and viewing verification for displaying important information (e.g., safety instructions in an emergency) on one or more display units. In one embodiment, the video input of the display unit also provides video input to a security system. Thus, pattern matching may be performed on viewers to identify dangerous individuals (e.g., terrorists or other criminal suspects). Additionally, the video input may be analyzed using other image processing techniques to determine whether a potentially dangerous activity is occurring (e.g., a possible kidnapper forcibly relocating a child or a possible terrorist bomber leaving a package, briefcase or other suspicious container unattended). In such emergencies, the display units may display helpful information (e.g., a safe escape route from the premises that does not go past the possible bomb or wanted individual). When it is necessary to keep the suspect unaware that the building is being evacuated, only the display units that are not in the suspect's general vicinity are used to deliver evacuation information.

It is also an object of the present invention to provide a method, system and apparatus for generating ad content by advertisers and placing said ad content in a database. The advertisers can also indicate how and when the ads should be displayed. For example, one advertiser indicates that an ad should be placed in the first display position as viewers enter a theater. Another advertiser indicates that an ad should be placed by the exit from all theaters-playing a specific movie and should be displayed as the movie lets out. In one embodiment, a scheduler uses fuzzy logic to schedule ad display lists. The time available for displaying ads on a display unit is partitioned into a plurality of bins. An advertiser may request that an ad be played during a period of time represented by a bin. The scheduler determines whether there is enough time in the bin to display the ad, and if there is, it adds the ad to the display list for that time period. In one embodiment, an advertiser may request an ad be played at a specific time. If that time is available, the scheduler further partitions the time bin containing the desired play time. When partitioning the bin, the scheduler places ads already scheduled to play in the original bin into the new bins in a pseudo-random manner designed to evenly disperse the ads into the new bins without playing one ad unacceptably frequently. In one embodiment, the display unit has filler ads used to fill gaps between requested ads. For example, during off-peak hours, not enough advertisers may wish to advertise to completely fill a 20 minute period of time. A company logo (e.g., the logo of the company that manages the display units or the logo of the company that owns the location) is displayed to fill the remaining time. In another embodiment, public service announcements of varying lengths are used as filler ads.

It is another object of the present invention to provide tools to advertisers for use in ad generation. In one embodiment, the tools enable the ad generator to easily arrange sound, still image and moving image files into an ad and specify how the ad behaves when idle or interacting with a viewer. In another embodiment, the tools enable the ad generator to easily generate a plurality of ads that interact together on a plurality of display units. In one embodiment, the tool provides display unit lay-out information for all locations containing display units. In another embodiment, the tool provides a standard set of display unit lay-outs (e.g., two units in a row, five units in a row or a unit in the middle of each wall of a room). In one embodiment, the tool provides a virtual three dimensional viewing environment so that the ad generator can view how the interacting displays will appear. The viewing environment enables the ad generator to rotate the view 360 degrees to view all display units on walls and enables the ad generator to shift the view up or down to view displays placed higher or lower than eye level on walls as well as any displays placed on the ceiling or floor.

These and other features, aspects and advantages of the present invention will become better understood with regard to the following description, appended claims, accompanying drawings and attachments.

### BRIEF DESCRIPTION OF THE DRAWINGS

These and other features, aspects and advantages of the present invention will become better understood with regard to the following description, appended claims and accompanying drawings where:

FIG. 1 is a block diagram of an architecture for a media distribution and viewing verification architecture in accordance with one embodiment of the present invention.

FIG. 2 is a block diagram of a display unit in accordance with one embodiment of the present invention.

FIG. 3 is a block diagram of a display unit in accordance with one embodiment of the present invention.

FIG. 4 is a flow diagram of the process of encouraging and verifying viewing in accordance with one embodiment of the present invention.

FIG. 5 is a flow diagram of the process of billing an advertiser in accordance with one embodiment of the present invention.

FIG. 6 is a flow diagram of the process of displaying content in accordance with one embodiment of the present invention.

FIG. 7 is a flow diagram of the process of displaying content based on viewer demographic data in accordance with one embodiment of the present invention.

FIG. 8 is a flow diagram of the process of distribution of content in accordance with one embodiment of the present invention.

FIG. 9 is a flow diagram of the process of displaying multi-display content in accordance with one embodiment of the present invention.

FIG. 10 is a flow diagram of the process of scheduling content in accordance with one embodiment of the present invention.

FIG. 11 is a flow diagram of the process of scheduling an ad in accordance with one embodiment of the present invention.

FIG. 12 is a block diagram of a sample report in accordance with one embodiment of the present invention.

### DETAILED DESCRIPTION OF THE INVENTION

The invention is a method, system and apparatus for media distribution and viewing verification. In the following description, numerous specific details are set forth to provide a more thorough description of embodiments of the invention. It is apparent to one skilled in the art, however, that the invention may be practiced without these specific details. In other instances, well known features have not been described in detail so as not to obscure the invention.

Media Distribution and Viewing Verification Architecture

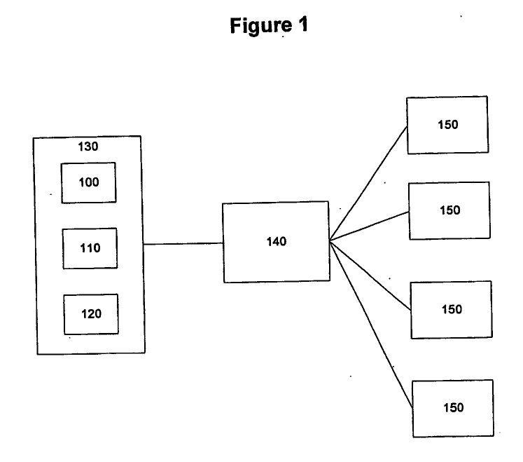

In one embodiment, media content is stored in a database. Media content from the database is arranged into a schedule and displayed on a display unit. FIG. 1 illustrates an architecture for a media distribution and viewing verification architecture in accordance with one embodiment of the present invention. Media content 100, schedule information 110 and viewer information 120 are stored in one or more central databases 130. The central database communicates with a local server 140 that manages a plurality of display units 150 at one site. In other embodiments, other architectures are implemented. For example, in one embodiment, there is no local server and the central database communicates directly with the display units. In another embodiment, a hierarchy of servers is between the central database and the local server.

In one embodiment, communication is secured by communicating over dedicated transmission lines (e.g., a local network between the local server and the display units). In another embodiment, communication is made secure by implementing one-way message passing with encryption (e.g., 128 bit encryption schemes) over insecure transmission lines (e.g., over the Internet between the central database and the local server or via wireless transmissions between the local server and display units).

Display Units

The present invention may comprise one or more display units. In one embodiment, a display unit comprises a flat panel display with stereo speakers placed in a wall in approximately the same space as is occupied by a traditional movie poster display case. In one embodiment, the flat panel display is a plasma display monitor. In another embodiment, other display systems (e.g., TV or computer monitor) are used. In one embodiment, the display unit is retrofitted to a traditional movie poster display case.

In another embodiment, the display unit is a stand alone unit, for example, sitting on or mounted to a floor. In alternative embodiments, the display unit is suited for positioning, mounting or affixing to a ceiling, counter, shelf, desk, dashboard, table, elevator, video intercom, vehicle body and the like.

In one embodiment, the display unit also comprises sensor units. One embodiment has motion sensors used in determining whether the display is being viewed. Another embodiment has video sensors used in determining whether the display is being viewed and/or determining the number of viewers. Yet another embodiment has a card reader sensor used to gather information about a viewer. Another embodiment has a touch-screen monitor used to gather information from a viewer. Still another embodiment has a climate sensor (e.g., thermometer, barometer, humidity sensor, wind sensor, air clarity sensor, etc.). Other embodiments have sensors used to receive information from portable electronic devices (e.g., cellular phones, PDAs or laptops). In one embodiment, the display unit also comprises a communications unit configured to transmit information to portable electronic devices. In one embodiment, an infrared port is used by the communications unit. In other embodiments, other communications means are used by the communications unit.

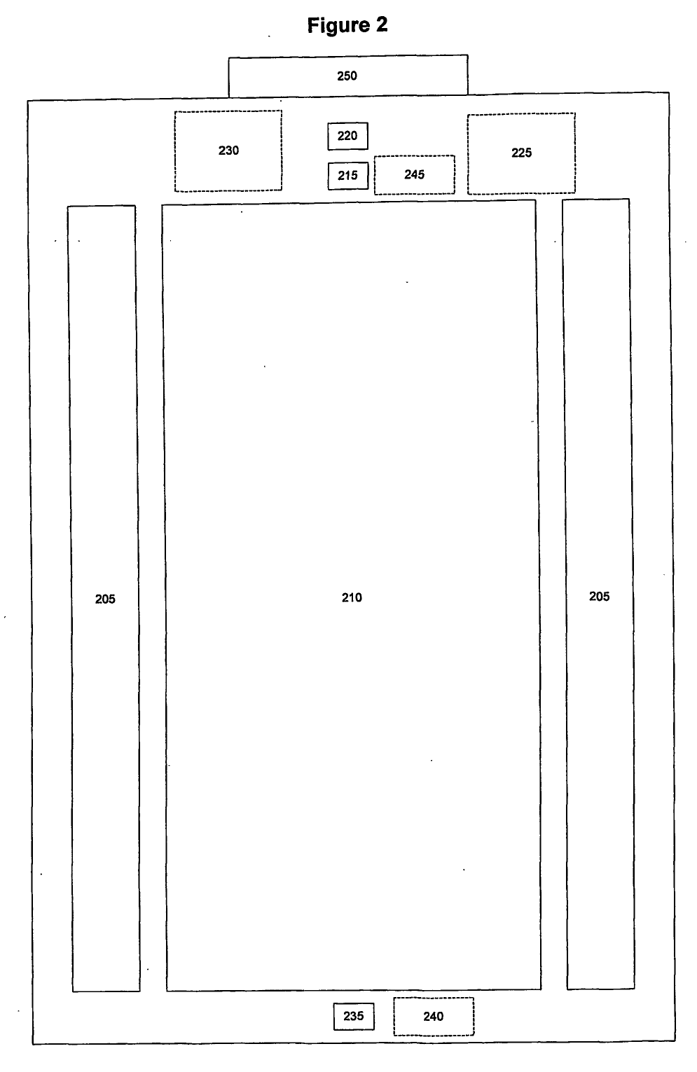

FIG. 2 illustrates a display unit in accordance with one embodiment of the present invention. The display unit 200 has stereo speakers 205 on either side of a flat screen 210. A proximity sensor 215 is used to detect when a viewer is near the display unit. In one embodiment, the proximity sensor is an ultrasonic sensor with a detection range of 10 feet. In one embodiment, the proximity sensor is also used to detect motion. For example, if a detected object is a threshold distance (e.g., 6 inches) closer to the display than a previously detected object, it may indicate that a new viewer has moved in front of an old viewer. It may also indicate the old viewer has moved closer to examine the ad playing on the display unit.

A video sensor 220 (e.g., a digital camera) is used to determine how many viewers are attending the ad that is currently playing. In one embodiment, the image captured by the video sensor is analyzed to determine whether movement has occurred (e.g., there is a change in the background) in front of the display unit. In another embodiment, the proximity sensor detects an object and signals a control unit 225 hidden inside the display unit. The control unit initiates the video sensor and the collected image is analyzed to determine (e.g., by blob detection, other pattern matching or other image processing techniques) how many viewers are viewing the currently playing ad. In one embodiment, the image is also analyzed to determine the sex and age of the viewers. In one embodiment, information collected by the sensors or generated from analysis of sensor data is stored in a log 230. In one embodiment, the log is maintained on the local server. In another embodiment, the log is maintained in the control unit (e.g., on a RAID storage device that also contains the control unit logic and operating system). In yet another embodiment, the log is maintained in its own separate storage unit.

A card reader 235 enables users to identify themselves to the display unit. The display unit retrieves information about the user (e.g., through the card reader, from the local server or from a central server) and alters its scheduled ad play list to tailor it to the identified user. For example, if the system determines the user has just seen a movie, the display unit may schedule an ad for a similar movie or an ad for a product engaged in cross-promotions with the movie.

Of course, the display units are not limited to movie theater locations. For example, a display unit in a museum may determine that a user is most interested in ancient Egypt and play an ad for an up-coming ancient Egyptian pottery display. A display unit in a grocery store-check-out line may determine that the user frequently purchases a product that is on sale and schedule an ad illustrating that sale price. Similarly, the display may determine what the viewer intended to purchase (e.g., from a shopping list entered by the user prior to coming to the store) and display the list to remind the viewer of any forgotten items. In another embodiment, a bar-code reader or other sensing device could automatically determine what items the viewer has in the basket and highlight any items from the list that the viewer forgot.

The display unit also has a cooling system 240 and temperature sensors 245 to prevent the display unit from overheating and to determine whether it is necessary to shut down some or all of the display unit. Additionally, the display unit has a traditional logo ad slot 250 so that a sponsor can display its image on the display unit.

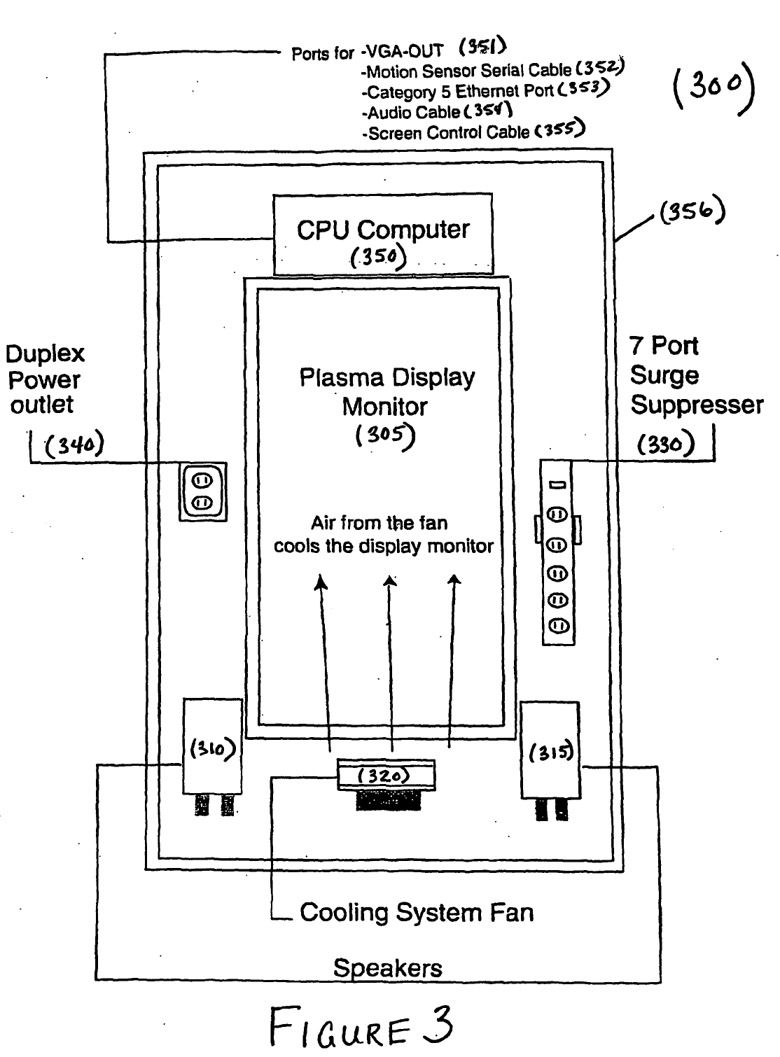

In one embodiment, in reference to FIG. 3, display unit 300 comprises plasma display monitor 305; speakers 310 and 315; cooling system fan 320 such that air from the fan cools display monitor 305; duplex power outlet 340; 7 port surge suppresser 330; and CPU computer 350. CPU computer 350 comprising ports for VGA-OUT 351; motion sensor serial cable 352; category 5 ethernet port 353; audio cable 354; and screen control cable 355. In one embodiment, display unit 300 comprises outer casing 356 comprising Kydex®, a tough, highly chemical resistant thermo set polymer.

Viewer Registration and Viewing Verification

In one embodiment, a viewer registers with the system to enable display units to identify the viewer. The viewer provides the system with a set of demographic information that will assist the display units in scheduling content tailored to the viewer. In one embodiment, a rewards system is established to encourage viewers to identify themselves to display units and view ads. In one embodiment, after a threshold amount of viewing, a viewer is given free merchandise, rebates on items, coupons or other special offers. In one embodiment, the frequency with which viewers can receive credit for identifying themselves and viewing ads is limited. For example, if the system requires a two hour wait between credit earnings for a viewer; even if the viewer is identified by a display unit at another location the viewer may view ads, the viewer will not receive another credit before the two hour wait is over.

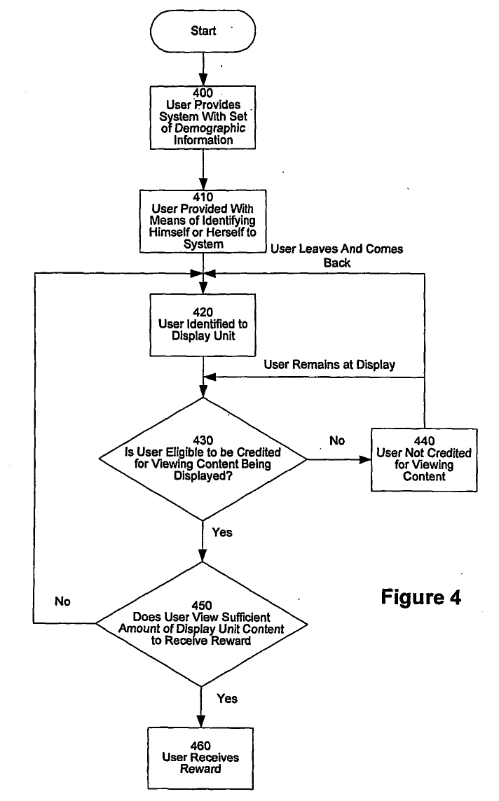

FIG. 4 illustrates the process of encouraging and verifying viewing in accordance with one embodiment of the present invention. At block 400, a user provides the system with a set of demographic information. In one embodiment, the user provides the information via an electronic interface (e.g., a website or telephonic system). In another embodiment, the user provides the information via non-electronic means (e.g., filling out and submitting a paper form or speaking directly with a system representative). At block 410, the user is provided with a means of identifying himself or herself to the system. In one embodiment, the user is provided with a smart card. In another embodiment, the user is provided with a code. In yet another embodiment, the user is provided instructions on supplying biometric information.

At block 420, the user is identified to a display unit. At block 430, it is determined whether the user is eligible to be credited for viewing the content being displayed. If the user is not eligible to be credited for viewing the content being displayed, at block 440, the user is not credited for viewing the content and if the viewer is still present when new content is initiated, the process repeats at block 430, otherwise the process repeats at block 420 the next time the user approaches a display unit. If the user is eligible to be credited for viewing the content being displayed, at block 450, it is determined whether the user views a sufficient amount of display unit content to receive a reward. If the user does not view a sufficient amount of display unit content to receive a reward, the process repeats at block 420 the next time the user approached a display unit. If the user views a sufficient amount of display unit content to receive a reward, at block 460, the user receives a reward.

In one embodiment, the display unit collects information about the number and type of viewers that attend each media segment. This information is logged and used to verify content viewing. In one embodiment, the information is transmitted to a database. Verified viewings are associated with a value which, in some embodiments, is combined with a baseline display value. For example, advertisers are charged one rate for displaying their ads (or a sponsored program such as a short film) as part of a regular schedule. Another (possibly additional) rate based on the number of viewers is charged when it is verified that viewers are viewing the ad. Still another (possible additional) rate based on the demographics of the viewer is charged when demographic information about a viewer is known. The above billing structure is also applicable to a logo display area on the unit. In one embodiment, billing information is automatically generated from the logged information stored in a central server. In one embodiment, a periodic rate is charged to display content regardless of the number of times the content is displayed. In various embodiments, additional charges are billed based on the number of times the content is displayed, the number of times the content is viewed, the amount of people viewing the content, and/or the number of people fitting a target demographic that view the content. In one embodiment, the billing information is automatically transmitted to the advertiser. In another embodiment, the billing information is used to automatically debit an advertiser's account. In various embodiments, the billing information is compiled and sent to the advertiser and/or used to debit the advertiser's account periodically. In various other embodiments, the billing information is sent to the advertiser and/or used to debit the advertiser's account as the system collects the information.

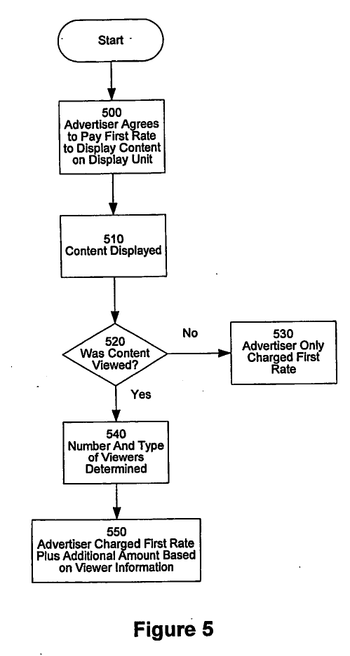

FIG. 5 illustrates the process of billing an advertiser in accordance with one embodiment of the present invention. At block 500, an advertiser agrees to pay a first rate to display content on a display unit. At block 510, the content is displayed. At block 520, it is determined whether the content was viewed. If it is not verified that the content was viewed, at block 530, the advertiser is only charged the first rate. If it is verified that the content was viewed, at block 540, the number and type of viewers is determined. At block 550, the advertiser is charged the first rate plus an additional amount based on the viewer information.

Predictive Analysis and Customer Relationship Management System (PA-CRMS)

In one embodiment, the information collected and logged by the display unit and/or transmitted to a database is analyzed by the PA-CRMS to create individualized reports for advertisers. In various embodiments, these reports are used to identify the need for actions, provide an insight and context for deciding on a course of action, and/or subsequently provide information/assessment on the effectiveness of a pursued course of action.

In one embodiment, the analysis and reporting are performed automatically by the PA-CRMS. In one embodiment, the analysis is performed in real-time. In various other embodiments, an individual or group using software tools within and/or independent of the PA-CRMS performs the analysis and reporting manually.

Practical usage examples of the PA-CRMS in accordance with various embodiments include, but are not limited to, monitoring, tracking and predicting traffic patterns; quantifying the success of marketing campaigns and/or anticipating individual customer responses to a particular campaign, predicting future outcome (e.g., box office trends); capitalizing on new selling opportunities; and offering products and services that are most relevant to customers.

Media Content

In one embodiment, the media content is segmented into ads. Ads comprise still video, moving video, audio and interactive feature instructions that define how the ad displays either in an interactive mode, an idle mode or a coordinated mode. For example, one ad is a still picture that displays until the display unit detects a viewer's presence. Once the viewer's presence is detected, the ad begins playing moving video and sound. In one embodiment, the still picture and moving video are arranged such that it appears to the viewers that the still image begins to move when they view the display. In yet another embodiment, the image from the video sensor is captured and used as part of an ad. In one embodiment, the image is analyzed to determine the location of a viewer. In one embodiment, the location of the viewer is used to influence the content that is displayed. In an example embodiment, a character's eyes (or pointing finger) are made to look at (or point at) and follow a viewer's location. In one embodiment, an ad occupies the entire display area. In another embodiment, the display area is partitioned to display one or more ads simultaneously.

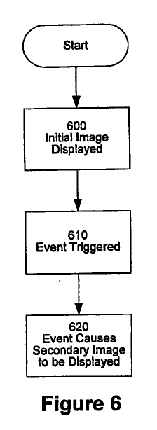

FIG. 6 illustrates the process of displaying content in accordance with one embodiment of the present invention. At block 600, an initial image is displayed. In one embodiment, the initial image is a still image. In another embodiment, the initial image is a moving (or otherwise changing) image. At block 610, an event is triggered. The event could be a motion event, card event or other triggering event (e.g., a time elapse). At block 620, the event causes a secondary image to be displayed. In one embodiment, the secondary image is a moving (or otherwise changing) image. In another embodiment, the secondary image is a still image.

Content Behavior

In one embodiment, each piece of content, in essence, is one “blob” (e.g., a reference file in a database) that may contain several parts. In one embodiment, any part may come to the surface based on activity or non-activity within the environment in which it is distributed. In one embodiment, the “living content” is described as “active one-sheets” with passive and active behavior moving from one state to another depending on a set of variables (e.g., the presence of an object or a human).

The Active One-sheet

In one embodiment, 30 seconds is one unit. In other embodiments, units are another length of time. In still other embodiments, units are of different lengths of time. In one embodiment, a studio or marketer purchases xNum of “units” or “spots.” In various embodiments, a unit is a video promo/trailer (linear video) or an “active one-sheet,” with sponsor logo. Active one-sheets are “thinking” pictures. Active one-sheets are comprised of at least two (2) possible states with respect to user interaction: static state and active state. In various embodiments, the ordering of active and static states in media content need not be the same. Upon triggers, the content can transition to an active state or a static state regardless of the current state. Additionally, media content's initial state can be active.

Static State (Inactive)

In one various embodiments, an active one-sheet begins from a “static” (non-moving) state. In other embodiments, the active one-sheet begins in an active state. In one embodiment, the static state active one-sheet has the appearance of a paper one-sheet. To a movie-patron, it is similar to a paper movie poster hung in light boxes.

Active State (Live)

In one embodiment, an active state is the progression of a “motion poster” or “active one-sheet” from a static poster to a moving image. In one embodiment, after some specified delay that is programmed by the creator, a static one-sheet will become active or “live.” The active state is designed to attract movie-patrons' attention to the display. In an example embodiment, the clouds in a landscape begin to move and Mel Gibson blinks. In another embodiment, if the active one-sheet succeeds in attracting a patron, it will result in a motion event

In one embodiment, the static and the active states together comprise a single unit. In an example embodiment, a static state remains non-moving for 10 seconds, and if it doesn't detect someone within the 10 second programmable threshold, an active state is triggered (i.e., the image begins to move), and the active state lasts 20 seconds comprising one, 30 second unit. In one embodiment, either state can be interrupted by a user through the following passive or requested events: motion event or card event

Motion Event (Passive)

In one embodiment, a motion event is triggered by movie-patrons drawn to and/or sensed by a smart poster display. In one embodiment, a motion event is uniquely measurable in addition to scheduled plays. In another embodiment, no “identity” or “profile” of a user is recorded. In one embodiment, reports generated indicate how many “BOOKED” units resulted in a triggered event (i.e., attracted a patron to watch the spot). In one embodiment, this helps in predictive filtering (e.g., determining box office ticket sales for a given film release or general interest in a product). In one embodiment, motion events indicate that a movie-patron is interested in a specific film release. In various embodiments, a system (e.g., the ThinkPix™ Network) is able to make box-office predictions using the motion events.

Card Event (Requested)

In one embodiment, a card event is triggered by a smartcard (i.e. AMC MovieWatcher™ card, etc), a portion of a food or beverage container (e.g., a soda-cup tear-away), keyfob or other similar item. In one embodiment, the card event triggers a specific co-promotional creative action. In another embodiment, the card event is uniquely measurable. In one embodiment, user data (e.g., identity) is captured. In another embodiment, the user data is captured through card ID info. In another embodiment, the user data is captured through web registration. In various embodiments, the user data contains information on who the user is and/or what their preferences are. In other embodiments, additional information is captured. In one embodiment, user data is captured on an opt-in basis.

In one embodiment, the database of users includes their email addresses, their favorite films and/or the products that interest them. In one embodiment, the user database allows a marketer to target its creative action (e.g., an ad in the form of a active one-sheet) at the audience that is most interested in it. In one embodiment, card events tell studios/co-marketers and/or promotional partners, precisely who has watched their spot. In one embodiment, cardholders earn points when they use a card. In another embodiment, the points are tracked at retail and/or used to purchase (or to reduce the purchase price of) sponsors' merchandise and/or studio ancillary products (e.g., DVD's, CD Soundtracks). In another embodiment, a card event is leveraged to alert movie-patrons of home release schedule for features of interest.

Interactive Scheduling

In one embodiment, the display unit determines the type of viewers using it and rearranges its display schedule to display ads that are of interest to the current viewers. For example, in one embodiment, image processing techniques are used to differentiate between men and women. When the viewers are predominantly or entirely one sex, ads tailored to that sex are scheduled. In an alternative embodiment, scheduled ads use the sex information about the viewers to control how the ad displays. For example, one set of background music plays for an all male audience, another set plays for an all female audience and still another plays for a mixed audience. Different still images, moving images and audio effects are available in an ad to tailor the ad for the audience's age, sex and/or other demographic make-up. For example, instead of creating two ads, one in English and one in Spanish, and targeting the English ad at locations where English is the predominant language and targeting the Spanish ad at locations where Spanish is the predominant language, the advertiser can create one ad that specifies the English or Spanish audio files are used as appropriate. When the ad plays in a location, it will determine the predominant language of the location and use the appropriate file. Additionally, if a viewer is identified, the ad may determine the viewer's preferred language and use the appropriate file.

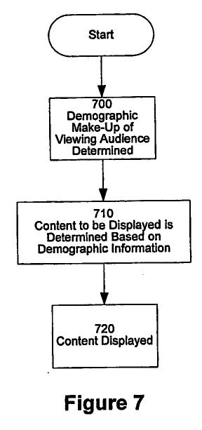

FIG. 7 illustrates the process of displaying content based on viewer demographic data in accordance with one embodiment of the present invention. At block 700, the demographic make-up of the viewing audience is determined; At block 710, the content to be displayed is determined based on the demographic information. At block 720, the content is displayed.

In one embodiment, the display unit's proximity to physical features of its landscape is used to determine the scheduling of content. In an example embodiment, display units located near the a concession area run ads for food while display units near the bathroom run short, attention getting content. In another embodiment, proximity to other display units affects the content being scheduled. In yet another embodiment, display units are grouped together to work as tiled pieces to a larger virtual display unit. In one embodiment, the distance to and orientation of each display unit in the group are stored upon installation so the system has the position and orientation information and has the option to schedule content produced to work in a multi-display environment. In various embodiments, groups of display units need not be contiguous.

In one embodiment, the display unit can identify individual viewers. For example, a viewer may present a smart card to the display unit containing information about the viewer. As the display unit displays ads, it modifies the information on the user's smart card. Thus, when the viewer presents its smart card to another display, the viewer's history can be taken into account when scheduling ads for the viewer.

In one embodiment, information about a user is stored in a database. When a display unit identifies an individual, it rearranges its ad display schedule to accommodate the individual given the information it has about the individual. For example, if a viewer likes action films, action film ads are scheduled for the display unit. If the viewer is only interested in Tom Cruise movies, ads for upcoming releases with Tom Cruise are scheduled. In some embodiments, the display unit will retrieve a set of information about a viewer from a smart card used to identify the viewer. The display unit will also send a request for more complete information and/or ad content to a database. The display unit stores a pool of ads it can play that fit a variety of demographics when necessary, but a more complete pool of ads is stored somewhere other than the display unit. In one embodiment, a local database contains an incomplete pool of ads and viewer information, but a more complete pool than the pools stored on individual display units. Only the ads that are deemed likely to be displayed within a period of time are stored on the local database. Additionally, only the viewer information of viewers deemed likely to be present is stored on the local database. If a display requests viewer or ad information not stored in the local database, the local database requests the information from a central database that stores a complete pool of ads and viewer information. Likewise, the display unit's interactions with a viewer may cause the viewer's information to be altered both on the local database and on the central database. In another embodiment, the viewer's information is updated on the viewer's smart card. In one embodiment, the local database updates its stored information from the central database on a regular basis.

In one embodiment, the display unit acquires its content remotely over a network connection. In one embodiment, content is sent to a display unit from a local server. In another embodiment, content is sent to a display unit from a remote server over a secure private network connection. In one embodiment, one or more live broadcast(s) is sent to a display unit and/or a group of display units. In one embodiment, the network bandwidth is insufficient to support live transmission of content, so the local server act to time delay live the one or more broadcast(s) to the display unit(s).

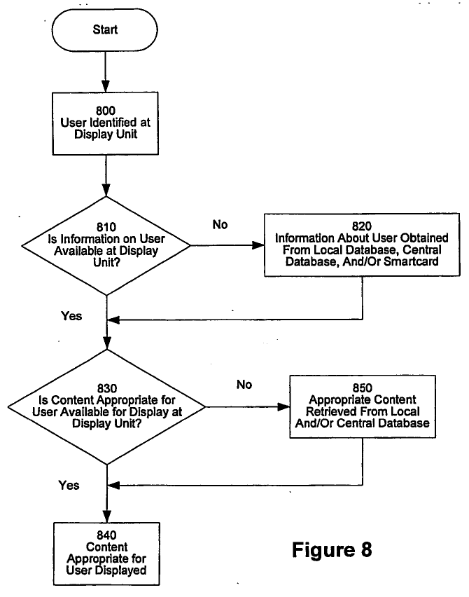

FIG. 8 illustrates the process of distribution of content in accordance with one embodiment of the present invention. At block 800, a user is identified at a display unit At block 810, it is determined whether information on the user is available at the display unit. If information on the user is not available at the display unit, at block 820, information about the user is obtained from a local database, central database, and/or a smartcard and the process continues at block 830. If information on the user is available at the display unit, at block 830, it is determined whether content appropriate for the user is available for display at the display unit. If content appropriate for the user is available for display at the display unit, at block 840, content appropriate for the user is displayed. If content appropriate for the user is not available for display at the display unit, at block 850, appropriate content is retrieved from a local and/or central database and the process continues at block 840.

Multiple Display Unit Ad Coordination

In one embodiment, ads are coordinated between multiple displays. Thus, an object (e.g., a character or non-character item) can be made to appear to travel (e.g., run, be projected or thrown, swim, etc.) from one display to another or objects and scenes on two different displays can interact (e.g., a character shooting a flame thrower onto another screen or two characters playing catch). In one embodiment, the relative positions of the interacting display units are used in scheduling the displays on each display unit. For example, if three displays are interacting with a character running from the first to the last display unit in a row and the first and second display are one unit apart while the second and third units are three units apart, the schedules of the displays on each unit are arranged such that it appears to take three times as long for the character to traverse the space between the second and third display units as it does to traverse the distance between the first and the second display. In one embodiment, the relative position of the display units is determined using a GPS receiver or through standard measuring techniques to build a scale 3 dimensional model of the location with the orientation of each display being noted in 360 degree measurements. In another embodiment, a coordination manager ensures that the display units being coordinated are properly arranged. Content created for multiple display units is tagged for use in certain display numbers and arrangements. For example, if Robin Hood is shooting an arrow to his right that hits a target and splits another arrow on another display, the coordination manager ensures that the display unit used for the target part of the ad is to the right of the display unit used for the Robin Hood shooting part of the ad.

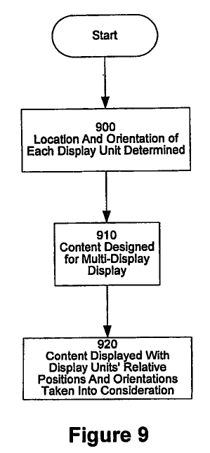

FIG. 9 illustrates the process of displaying multi-display content in accordance with one embodiment of the present-invention. At block 900, the location and orientation of each display unit is determined. At block 910, content is designed for multi-display display. At block 920, the content is displayed with the display units' relative positions and orientations taken into consideration. In one embodiment, the relative positions and orientations are taken into consideration by staggering the beginning of animated sequences on the display units. In another embodiment, elements of the content are dynamic, so the content can be adjusted to compensate for position and orientation before display.

In one embodiment, the coordination manager also works with the interactive scheduler to determine the correct content to schedule based upon known upcoming multi display events. In an example embodiment, when there are time based events scheduled which require the participation of all the display units in a location, the coordination manager will not allow content to play that will not finish playing or have a specified acceptable out point (e.g., transition or potential quitting point) before the scheduled beginning of the multi display event. Similarly, the coordination manager, in some embodiments, ensures that there are a proper number of displays (e.g., zero) between the two coordinating displays.

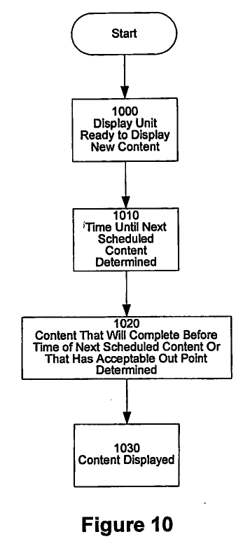

FIG. 10 illustrates the process of scheduling content in accordance with one embodiment of the present invention. At block 1000, a display unit is ready to display new content. At block 1010, the time until the next scheduled content is determined. At block 1020, content that will complete before the time of the next scheduled content or that has an acceptable out point (e.g., a fade transition or still moment) is determined. At block 1030, the content is displayed.

In one embodiment, the stereo and surround sound effects are also coordinated between the coordinated display units. For example, if two display units next to each other are used in a coordinated display, the left and right speakers of the left display unit will play the sound for the “left speaker” of the ad and the left and right speakers of the right display unit will play the sound for the “right speaker” of the ad.

Security Displays

In one embodiment, a local administrator may interrupt regular scheduling on display units to display important information (e.g., safety instructions in an emergency). In one embodiment, the video input of the display unit also provides video input to a security system. Thus, pattern matching may be performed on viewers to identify dangerous individuals (e.g., terrorists or other criminal suspects). Additionally, the video input may be analyzed using other image processing techniques to determine whether a potentially dangerous activity is occurring (e.g., a possible kidnapper forcibly relocating a child or a possible terrorist bomber leaving a package, briefcase or other suspicious container unattended). In such emergencies, the display units may display helpful information (e.g., a safe escape route from the premises that does not go past the possible bomb or wanted individual). When it is necessary to keep the suspect unaware that the building is being evacuated, only the display units that are not in the suspect's general vicinity are used to deliver evacuation information.

Generation of Ad Content and Scheduling

In one embodiment, ad content is generated by advertisers and placed in the ad database. In one embodiment, a descriptive language is used to indicate the content of pieces of an ad and how the pieces should interact. The advertisers also indicate how and when the ads should be displayed. For example, one advertiser indicates that an ad should be placed in the first display position as viewers enter a theater. Another advertiser indicates that an ad should be placed by the exit from all theaters playing a specific movie and should be displayed as the movie lets out.

In one embodiment, a scheduler uses fuzzy logic to schedule ad display lists. The time available for displaying ads on a display unit is partitioned into a plurality of bins. An advertiser may request that an ad be played during a period of time represented by a bin. The scheduler determines whether there is enough time in the bin to display the ad, and if there is, it adds the ad to the display list for that time period. In one embodiment, an advertiser may request an ad be played at a specific time. If that time is available, the scheduler further partitions the time bin containing the desired play time. When partitioning the bin, the scheduler places ads already scheduled to play in the original bin into the new bins in a pseudo-random manner designed to evenly disperse the ads into the new bins without playing one ad unacceptably frequently.

In one embodiment, the display unit has filler ads used to fill gaps between requested ads. For example, during off-peak hours, not enough advertisers may wish to advertise to completely fill a 20 minute period of time. A company logo (e.g., the logo of the company that manages the display units or the logo of the company that owns the location) is displayed to fill the remaining time. In another embodiment, public service announcements of varying lengths are used as filler ads.

In one embodiment, the generated ads are stored in a central database, but must be approved by a system administrator before being available for play. Thus, the system administrator can ensure that ads comply with any standards the media distributor may set.

In one embodiment, ads are assigned a priority. In one embodiment, a higher rate is charged to obtain a higher priority. Ads with a higher priority are able to displace ads with a lower priority in the display schedule. In another embodiment, higher priority ads are simply scheduled first so that they don't compete with lower priority ads for desired times. In one embodiment, an advertiser can schedule an ad to play a specific number of times in each display unit at a location. For example, ads A, B, C and D are scheduled to play twice on each display unit. In one embodiment, the order the ads are played is randomly determined for each unit. Thus, display unit 1 may play B, C, D, A, B, C, D, A while display unit 2 plays D, C, A, B, D, C, A, B. In this example, the order of play is random for the first playing, but the pattern is repeated as a loop after the first playing. In other embodiments, the order of repeat playings is also random; However, in one embodiment, the randomness of repeat playings is limited by not allowing the same ad to play within a threshold amount of time of its previous playing.

In one embodiment, high priority ads are able to lock a display unit a period of time before the ad is scheduled to play to ensure it is available at the appropriate time. For example, a coordinated ad that uses every display unit at a location locks each station a minute before it is scheduled to play to prevent users from identifying themselves to individual display units and viewing different ads.

In one embodiment, display units are attached to the theater clock. Therefore, ads may be scheduled to play as a movie lets out or as a movie is about to begin. Display units not located in movie theaters may also be attached to a clock for the venue to assist targeted ad scheduling. For example, display systems in airports are, in some embodiments, attached to the airport clock to enable scheduling of ads around airplane departure or arrival times.

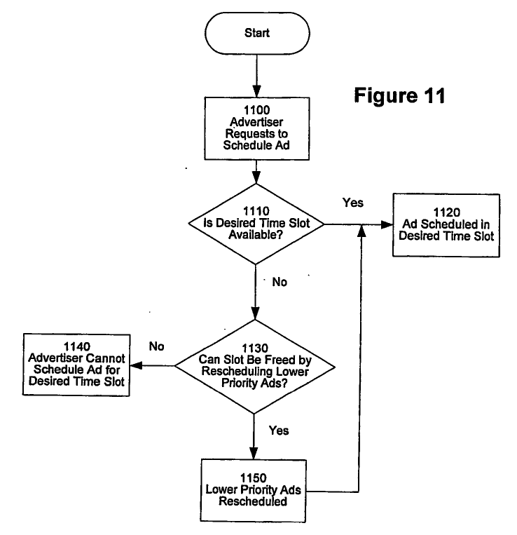

FIG. 11 illustrates the process of scheduling an ad in accordance with one embodiment of the present invention. At block 1100, an advertiser requests to schedule an ad. At block 1110, it is determined whether the desired time slot is available. If the desired time slot is available, at block 1120, the ad is scheduled in the desired time slot. If the desired time slot is not available, at block 1130, it is determined whether the slot can be freed by rescheduling lower priority ads. If the slot cannot be freed by rescheduling lower priority ads, at block 1140, the advertiser cannot schedule the ad for the desired time slot. If the slot can be freed by rescheduling lower priority ads, at block 1150, lower priority ads are rescheduled and the process proceeds at block 1120.

In one embodiment, tools are provided to advertisers for use in ad generation. In one embodiment, the tools enable the ad generator to easily arrange sound, still image and moving image files into an ad and specify how the ad behaves when idle or interacting with a viewer. In another embodiment, the tools enable the ad generator to easily generate a plurality of ads that interact together on a plurality of display units. In one embodiment, the tool provides display unit lay-out information for all locations containing display units. In another embodiment, the tool provides a standard set of display unit lay-outs (e.g., two units in a row, five units in a row or a unit in the middle of each wall of a room). In one embodiment, the tool provides a virtual three dimensional viewing environment so that the ad generator can view how the interacting displays will appear. The viewing environment enables the ad generator to rotate the view 360 degrees to view all display units on walls and enables the ad generator to shift the view up or down to view displays placed higher or lower than eye level on walls as well as any displays placed on the ceiling or floor.

Personalized Previews/Movies

In another embodiment, the ads are displayed on the theater screen. Audience members identify themselves at their seats or on their way into the theater and the group demographics are used to determine which ads to play and/or how to play each ad. For example, if everyone on the audience is a fan of graphic violence, graphically violent scenes in an ad for a movie are left in. If the audience is composed largely of families, nude scenes are removed from ads and ads for more family oriented products, services, movies and the like are displayed. In another embodiment, ads are feature length movies. Again, the audience demographic is identified and the ad is tailored for the audience (e.g., altering the soundtrack, eliminating or including scenes or even altering the ending). In another embodiment, real time data is collected and analyzed to tailor the experience to the audience. In an example embodiment, a microphone is placed in the location to measure the decibel level to gauge audience feedback. In another embodiment, biometric input devices are used to monitor to physical characteristics of viewers, gauging audience feedback.

Billing—Verified View

In one embodiment, a verified view represents a user (e.g., a movie-patron) who views an active one-sheet (motion poster) or other displayed content for at least half the creative's length (wherein “creative” refers to the displayed content, connoting its creative aspects). In an example embodiment, a verified view represents a user viewing a 30 second active one-sheet for at least 15 seconds. In other embodiments, a verified view results from a different fractional (or whole) viewing of the creative. In still other embodiments, a verified view results from a user viewing a creative for a fixed amount of time, regardless of the creative's entire length. In one embodiment, a verified viewing is determined by parsing the motion event and/or play log data (ultrasonic detection or other) for a triggered event. In various embodiments, the event is triggered by either a user interaction or by a schedule play indicating that a person was present in front of the poster when the spot was run. In one embodiment, the data is further parsed to determine the distance to the user and/or how long the user was present when the spot ran. In one embodiment, stickiness is contingent upon how “interesting” the content is. In one embodiment, this data assists in predicting how well a movie and/or sponsor's product may be received when released.

Billing—Reporting

In one embodiment, a report is generated at the close of each time period (e.g., 1 month). In one embodiment, a report is generated on demand, regardless of whether a time period has completed. In various embodiments, reports indicate: booked units (scheduled plays), executed plays (number actually played), total number of motion events, (the number of units triggered by user “interest” through passive interaction), verified views (the number of units watched for specified length of time), and/or total number of card events (the number of units played on-demand or by-request). In one embodiment, studio one-sheet reports, indicate interest by movie-patrons by way of graph (e.g., compared to other film releases).

FIG. 12 illustrates a sample report in accordance with one embodiment of the present invention. The information about the content includes the title, studio, campaign, start date, end date, flight, cost, campaign parameters, primary market, secondary market, monthly reach, reporting parameters, other parameters, creative description, release date, related release dates, and the number of scheduled plays, motion trigger plays, IA time plays, total motion trigger and IA time plays, total motion events and verified views.

Billable

In one embodiment, since motion events and card events are conditional upon specific “passive” or “requested” interaction, there is no way to know precisely how many additional “triggered” units will occur. In one embodiment, billing for these units is handled separately (e.g., tallied at the end of each campaign). In one embodiment, a sponsor can cap and/or lock budget spending and/or media buys. In one embodiment, a sponsor who caps spending can reap rewards from over-reach.

In one embodiment, content spots are reserved by an initial buyer (e.g., a studio) under an initial fee structure. In another embodiment, the initial buyer resells the content spots to a secondary buyer (e.g., a promotional partner of the studio) under a second fee structure. In one embodiment, when the initial buyer is unable to resell some or all of the reserved content spots, the initial buyer is not obligated to purchase the content spots it could not resell. In another embodiment, the initial buyer is obligated to purchase all of the content spots it reserved.

1. A method for media distribution comprising: storing a plurality of media content in a database; generating a play schedule for a display unit; and displaying elements of said plurality of media content at said display unit in accordance with said play schedule.

2. The method of claim 1 further comprising: collecting a set of environmental data at said display unit.

3. The method of claim 2 further comprising: altering said play schedule in response to said set of environmental data.

4. The method of claim 3 wherein said environmental data comprises demographic information.

5. A method of media display comprising: displaying a media item in a first state; receiving a trigger event; and displaying a media item in a second state.

6. The method of claim 5 wherein said trigger event is a time elapse, motion event card event, multiple display event, or one or more synched events.

7. (cancelled)

8. (cancelled)

9. A method of media distribution comprising: obtaining a set of information associated with a display unit; and displaying a media element wherein said media element is associated with said set of information.

10. The method of claim 9 wherein said step of obtaining comprises: identifying a viewer; and obtaining a second set of information associated with said viewer.

11. The method of claim 9 wherein said step of obtaining comprises: obtaining a second set of environmental data.

12. The method of claim 11 wherein said set comprises demographic information associated with one or more viewers of said display unit.

13. A method of media distribution comprising: charging a content provider a first rate for displaying a content element; and charging said content provider a second rate for displaying said content element, if it is verified that said content element was viewed.

14. The method of claim 13 wherein it is verified that said content element was viewed by a viewer associated with a desired demographic element.

15. A method of media distribution comprising: reserving a content nm by an initial purchaser at a first rate; and attempting to resell said content nm to a secondary purchaser at a second rate.

16. The method of claim 15 further comprising: charging said initial purchaser at said first rate, only if said content run is resold to a secondary purchaser.

17. A method of scheduling media display comprising: requesting a play time for a media element; determining whether said content element can be played during said play time; and scheduling said content element during said play time, if said content element can be played during said play time.

18. The method of claim 17 wherein said play time is a period of time or an instance in time.

19. (cancelled)

20. The method of claim 17 wherein said step of determining comprises: assigning a media element priority to said media element; and determining whether rescheduling one or more scheduled media elements with lower priority than said media element priority will enable said media element to be scheduled during said play time.

21. A media distribution system comprising: a database configured to store a plurality of media content; a scheduling unit configured to generate a play schedule; and a display unit configured to display elements of said plurality of media content at said display unit in accordance with said play schedule.

22. The media distribution system of claim 21 further comprising: a collection unit configured to collect a set of environmental data at said display unit.

23. The media distribution system of claim 22 further comprising: a schedule alteration unit configured to alter said play schedule in response to said set of environmental data.

24. The media distribution system of claim 23 wherein said environmental data comprises demographic information.

25. A media display system comprising: a first display sub-system configured to display a media item in a first state; an event receiver configured to receive a trigger event; and a second display sub-system configured to display a media item in a second State.

26. The media display system of claim 25 wherein said trigger event is a time elapse, motion event, card event, multiple display event, or one or more synched events.

27. (cancelled)

28. (cancelled)

29. A media distribution system comprising: an obtaining unit configured to obtain a set of information associated with a display unit; and a display unit configured to display a media element wherein said media element is associated with said set of information.

30. The media distribution system of claim 29 wherein said obtaining unit comprises: an identification unit configured to identify a viewer; and a second obtaining unit configured to obtain a second set of information associated with said viewer.

31. The media distribution system of claim 29 wherein said obtaining unit comprises: a second obtaining unit configured to obtain a second set of environmental data.

32. The media distribution system of claim 31 wherein said set comprises demographic information associated with one or more viewers of said display unit.

33. A media distribution system comprising: a first pricing sub-system configured to charge a content provider a first rate for displaying a content element; and a second pricing sub-system configured to charge said content provider a second rate for displaying said content element, if it is verified that said content element was viewed.

34. The media distribution system of claim 33 wherein it is verified that said content element was viewed by a viewer associated with a desired demographic element.

35. A media distribution system comprising: a reservation unit configured to reserve a content run by an initial purchaser at a first rate; and a resell sub-system configured to attempt to resell said content run to a secondary purchaser at a second rate.

36. The media distribution system of claim 35 further comprising: a pricing sub-system configured to charge said initial purchaser at said first rate, only if said content run is resold to a secondary purchaser.

37. A media display scheduling system comprising: a requesting unit configured to request a play time for a media element; a determiner configured to determine whether said content element can be played during said play time; and a scheduler configured to schedule said content element during said play time, if said content element can be played during said play time.

38. The media display scheduling system of claim 37 wherein said play time is a period of time, instance in time, multiple display event, or one or more synched events.

39. (cancelled)

40. The media display scheduling system of claim 37 wherein said determiner comprises: an assignment unit configured to assign a media element priority to said media element; and a second determiner configured to determine whether rescheduling one or more scheduled media elements with lower priority than said media element priority will enable said media element to be scheduled during said play time.

41. (cancelled)

42. (cancelled)

43. (cancelled)

44. (cancelled)

45. (cancelled)

46. (cancelled)

47. (cancelled)

48. (cancelled)

49. (cancelled)

50. (cancelled)

51. (cancelled)

52. (cancelled)

53. (cancelled)

54. (cancelled)

55. (cancelled)

56. (cancelled)

57. (cancelled)

58. (cancelled)

59. (cancelled)

60. (cancelled)

61. (cancelled)

62. (cancelled)

63. (cancelled)

64. (cancelled)

65. A media display system comprising: two or more display systems connectively configured to display related media content; and one or more event receivers configured to receive one or more trigger events.

66. The media display system of claim 65, wherein said one or more event receivers is configured to receive a trigger event from an external source.

67. The media display system of claim 66, wherein said external source is a display unit.

68. The media display system of claim 65, wherein said system comprises one or more scheduling units configured to generate a play schedule.

69. The media display system of claim 68, wherein said one or more event receivers is configured to receive a trigger event from said play schedule.

70. The media display system of claim 65, wherein said trigger event is a time elapse, motion event or card event.

71. (cancelled)

72. (cancelled)
